(19) United States
(12) Patent Application Publication
(10) Pub. No.: US 2025/0156752 A1
(43) Pub. Date: May 15, 2025

(54) DATA AUGMENTATION USING DIFFERENT IN-DOMAIN DATA

(71) Applicant: INTERNATIONAL BUSINESS MACHINES CORPORATION, ARMONK, NY (US)

(72) Inventors: Youngja Park, Princeton, NJ (US); Weiqiu You, Philadelphia, PA (US)

(21) Appl. No.: 18/509,395

(22) Filed: Nov. 15, 2023

(51) Int. Cl. G06N 20/00

(52) U.S. Cl. CPC G06N 20/00

(57) ABSTRACT

A method, computer system, and a computer program product are provided for data augmentation for training an artificial intelligence (AI) engine. The technique comprises encoding an in-distribution dataset having a plurality of components and an out-of-distribution dataset also having a plurality of components. The encoding is performed using a foundation model. The techniques also comprises pairing one in-distribution component from the dataset with an out-of-distribution component from the dataset in a same class to provide a first set of paired component and pairing another in-distribution component with another out-of-distribution component in a different class using the contrastive learning model to provide a second set of paired components. The first and second set of pared components are then augmented to generate an augmented training dataset. The foundation models is adjusted by using he augmented training dataset to train the AI engine.

### BACKGROUND

The present invention relates generally to the field of data management and more particularly to techniques for data augmentation using different in-domain data.

Sentence classification may be defined by identifying sentences which contain certain information. This may be an important task for many computer applications. For instance, in the cybersecurity domain, automatic classification of attack techniques or mitigation techniques from sentences in Cyber Treat Intelligence (CTI) reports is very helpful for Security Operations Center (SOC) analysts to understand the cyberthreats. Other sentence classification includes classifying sentences for a particular purpose not related to cyber security. For example, in one scenario, this may relate to classification of sentences from clinical notes into certain disease types. In a different scenario this may include classifying user reviews into different sentiments.

The use of artificial intelligence (AI) engines using machine learning models have made sentence classification techniques even more popular. Different types of sentence classification techniques have been studied, but many of them have a variety of shortcomings. For one, most existing techniques require a large amount of labeled data to train the machine learning models. In many instances, this requires manually annotating a sufficient number of texts for each task. In addition, when there is not a large amount of data available, there is a challenge to design models that can efficiently develop a model by using a small amount of labeled data.

### SUMMARY

Embodiments of the present invention disclose a method, computer system, and a computer program product provided for data augmentation used for training an artificial intelligence (AI engine. The technique comprises encoding an in-distribution dataset having a plurality of components and an out-of-distribution dataset also having a plurality of components. The encoding is performed using a foundation model. The technique further comprises pairing one in-distribution component from the dataset with an out-of-distribution component from the dataset in a same class to provide a first set of paired component and pairing another in-distribution component with another out-of-distribution component in a different class using the contrastive learning model to provide a second set of paired components. The first and second set of pared components are then augmented to generate an augmented training dataset. The foundation models is adjusted by using he augmented training dataset to train the AI engine.

### BRIEF DESCRIPTION OF THE SEVERAL VIEWS OF THE DRAWINGS

These and other objects, features and advantages of the present invention will become apparent from the following detailed description of illustrative embodiments thereof, which may be to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment, according to at least one embodiment;

FIG. 2 illustrates an operational flowchart for providing a data augmentation process, according to one embodiment;

FIG. 3 provides a block diagram illustrating contrastive learning in a data augmentation process, according to one embodiment;

FIG. 4 illustrates a block diagram of an encoding process, according to one embodiment;

FIG. 5a is a block diagram illustration of an auxiliary data selection process, according to one embodiment;

FIG. 5b is a block diagram illustration of a two-stage model training, according to one embodiment; and

FIGS. 6a and 6b is graphical example of the process of the embodiment of FIGS. 5a and 5b with FIG. 5a corresponding to an auxiliary data selection process and FIG. 6b corresponding to the two-stage model training.

### DETAILED DESCRIPTION

Detailed embodiments of the claimed structures and methods may be disclosed herein; however, it can be understood that the disclosed embodiments may be merely illustrative of the claimed structures and methods that may be embodied in various forms. This invention may, however, be embodied in many different forms and should not be construed as limited to the exemplary embodiments set forth herein. Rather, these exemplary embodiments may be provided so that this disclosure will be thorough and complete and will fully convey the scope of this invention to those skilled in the art. In the description, details of well-known features and techniques may be omitted to avoid unnecessarily obscuring the presented embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

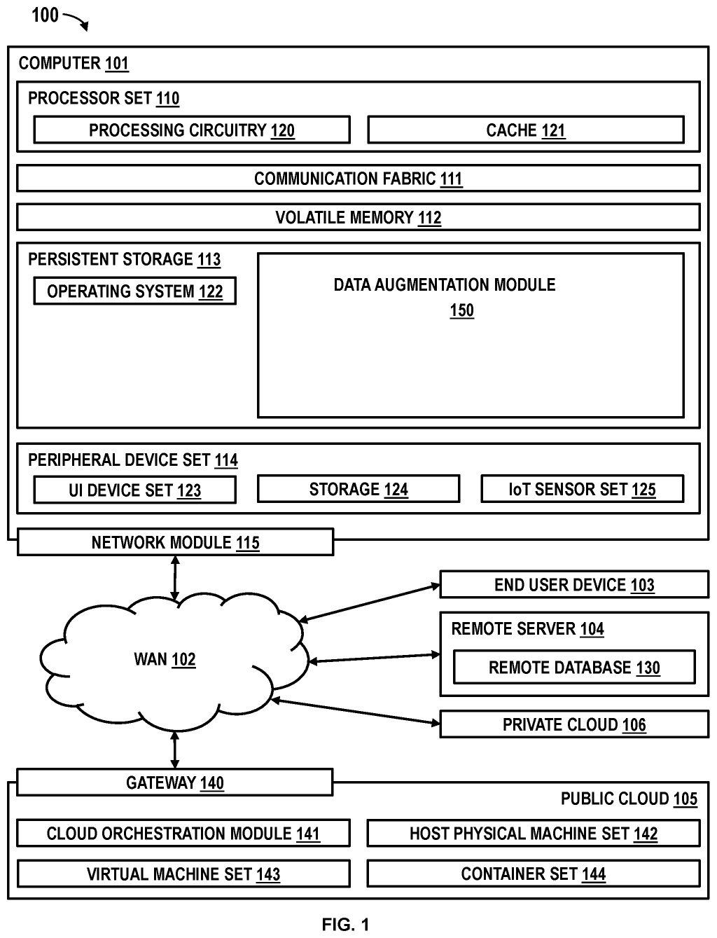

FIG. 1 provides a block diagram of a computing environment 100. The computing environment 100 contains an example of an environment for the execution of at least some of the computer code involved in performing the inventive methods, such as code change differentiator which is capable of improving data management using a Data Augmentation Module (150). In addition to this block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 of FIG. 1 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and rewriting of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

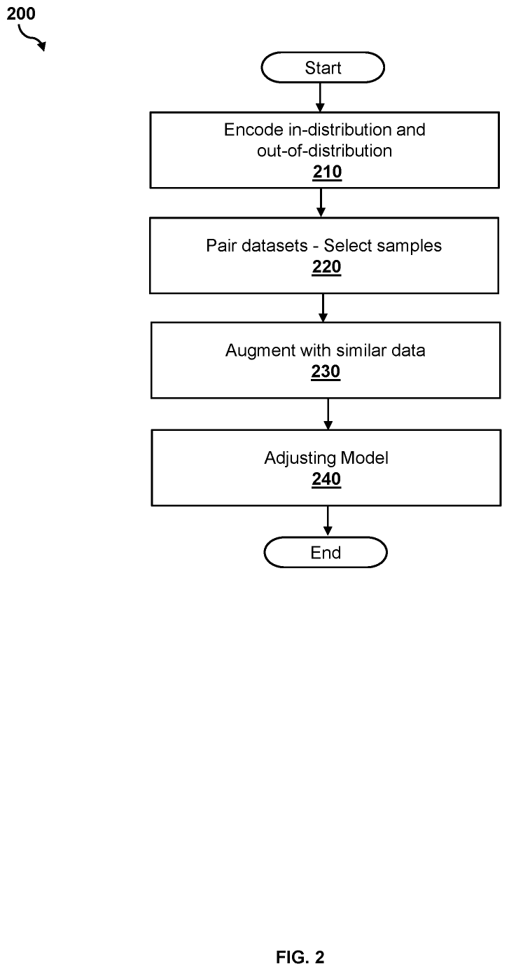

Sentence classification often involves identifying sentences which contain certain information and may be an essential task for many applications. For instance, in the cybersecurity domain, automatic classification of attack techniques or mitigation techniques from sentences in CTI reports is very helpful for SOC analysts to understand the cyberthreats. Other sentence classification examples include classifying sentences from clinical notes into certain disease types or classifying user reviews into different sentiments. Most of these existing prior art requires a large amount of labeled data to train the models. Manually annotating a sufficient number of text for each task consumes a huge amount of human effort. The process discussed in FIG. 2 provides a solution to prior art shortcomings.

FIG. 2 is a flowchart providing an illustration of a process 200 that addresses the lack of labeled data problem. Process 200, in one embodiment, may build a deep learning-based sentence classification model with a small amount of labeled data for the given task. In this embodiment, the process 200, augments the task-specific labeled data (referenced as in-distribution data) with other existing labeled or quasi-labeled data (referenced as out-of-distribution data). The process 200, uses contrastive learning to make the two datasets have more similar distribution. In one embodiment, the process 200, will first project in-distribution data and out-of-distribution data into a shared semantic space, and then selects some of out-of-distribution data that are especially in the similar distribution as the in-distribution data and train on them. These concepts can be viewed in more detail by looking at the process steps below.

The process 200 relies on a small amount of amount of training data labeled for the target task (Primary Data) and augments the labeled data using other existing labeled data or quasi-labeled data (Auxiliary Data). Examples of other existing labeled data can include: (1) data for a similar task from slightly different domain; and (2) Quasi-labeled data (definition or description text for the target classes) Other examples of such quasi-labeled data include glossary or annotation guidelines.

In Step 210, the process 200 primary and auxiliary sentences using a foundation model. In one embodiment, this includes encoding in-distribution and out-of-distribution sentences. The in-distribution sentences may be labeled as training data for a target task. The out-of-distribution sentences may be comprised of as other existing labeled data, or alternatively be quasi labeled data. In one embodiment, the process can use Bidirectional Encoder Representation from Transformers (BERT). BERT is a deep learning model in which every output element is connected to every input element. In this embodiment, a weighting factor may be dynamically calculated based upon the connections.

In one embodiment, the process 200 pairs one in-distribution sentence with an out-of-distribution sentence in the same class as similar, and an out-of-distribution sentence in a different class as dissimilar. This is to implement a contrastive learning model in one embodiment.

In Step 220, the process 200 may use a contrastive learning to maximize the cosine similarity between the embeddings of sentences of the two datasets from the same class. It selects some sentences from the out-of-distribution dataset that are most similar to at least one in-distribution sentence of the same class. In one embodiment, this can further be summarized as selecting some sentences from the auxiliary dataset that are most similar to at least one primary sentence of the same class.

In one embodiment, for each sentence in the auxiliary dataset, compute its cosine similarity with each sentence in the same class but in the primary dataset. Then the highest similarity score is selected as the score for this sentence in the auxiliary dataset. (In Step 220, similar data is selected such that for each sentence in the out-of-distribution dataset, its cosine similarity is computed with each sentence in the same class but in the in-distribution dataset. The process then selects the highest similarity score as the score for this sentence in the out-of-distribution dataset). In one embodiment, one in-distribution component from the dataset is paired with an out-of-distribution component from the dataset in a same class and an out-of-distribution component in a different class, and contrastive learning model can be used in one embodiment. In one embodiment, the process 200 selects the top-k sentences from out-of-distribution dataset for classes with fewer than “k” number of sentences in the in-distribution dataset, and appends those sentences to the training data.

In Step 230, the in-distributed dataset is augmented with the selected similar components from the out-of-distribution dataset.

In Step 240, the foundation model is adjusted. In one embodiment this involves tuning and fine-tuning of the model. The fine-tuning may be performed using contrastive learning (such as from Step 210), for sequence classification with all in-distribution data along with these selected sentences (Step 220) from out-of-distribution data. In one embodiment, the process further fine tunes the foundation model from Step 230 on only the in-distribution data. In one embodiment, the model can be implemented with a number of tools as known by those skilled in the art such as in PyTorch (PyTorch is a Trademark of Linux Foundation) using HuggingFace (HuggingFace is a Trademark of Hugging Face Inc.) library (for example when using foundation models like BERT.) The final fine-tuned model can then be deployed and further adapted accordingly.

In one embodiment, the finetuning can first be performed for sequence classification with all primary data along with these selected sentences from auxiliary data. Further finetuning is then done using the foundation model on only the primary data.

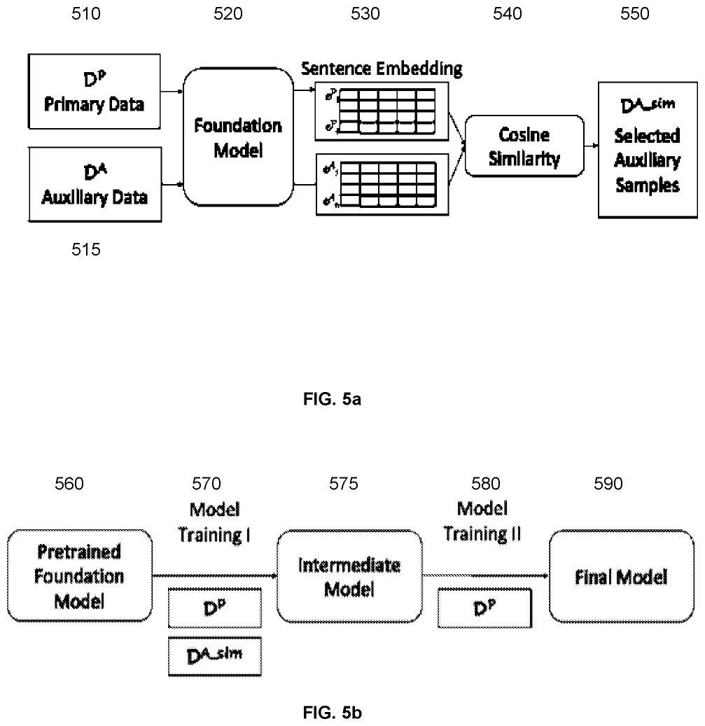

In one embodiment, the process may be re-iteratively and dynamically repeated. FIGS. 5a and 5b show an alternate embodiment to FIG. 2 where the process 200 can be used with auxiliary data a as shown in block diagram of FIG. 5a and as a two-stage model training as provided in block diagram of FIG. 5b. In FIG. 5a, the primary report dataset 510 and an auxiliary description dataset 515 are both provided to the Foundation model 520. This can be used with contrastive learning to increase cosine similarity as in 540 using sentence embedding 530 (for primary and auxiliary data from the same classes while decreasing the similarity for sentences from different classes.) Then some sentences are selected from the auxiliary data that are more similar to primary data and append those to the training set as shown in 550.

In one embodiment, as shown in FIG. 5b, a two-stage model training can be used to first pre-train a model 560 to create a first model or Model Training I 570 (using primary data and selected auxiliary samples) that will create an intermedia model 575 which will lead to creation of model training II 580 (using only primary data) to create the Final Model 590. The process can also use additional small quasi-labeled data while previous works mostly use additional large unlabeled data. In one embodiment, data is only augmented to the rare classes, simultaneously increasing data balance.

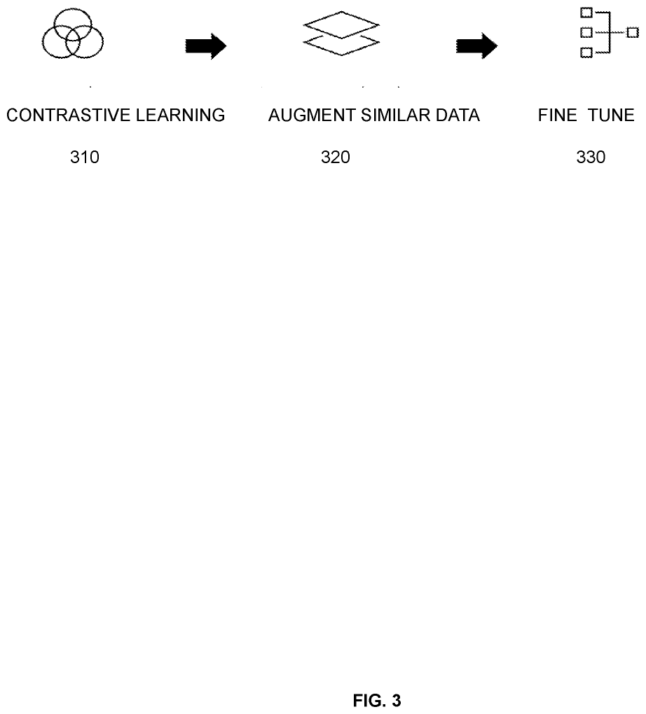

FIG. 3 provides a block diagram, illustrative the use of contrastive learning to augment data as discussed in connection with FIG. 2. In FIG. 3, contrastive learning 310 is used to select similar data to augment the in-distribution data in 320 to provide an implemented model by further fine-tuning it in 330. In the embodiment of FIG. 3, data augmentation for sentence classification tasks can be performed by relying on a small amount of training data labeled for the target task (e.g., attack technique classification, sentiment classification) and augmenting the labeled data using other existing labeled data or quasi-labeled data. As shown, the in-distribution data and out-of-distribution data is projected into a shared semantic space. Subsequently, some of out-of-distribution data that are especially in the similar distribution as the in-distribution data is selected and used for training. In other words, in one embodiment, the primary data and auxiliary data into a shared semantic space, and then select some of auxiliary data that are especially in the similar distribution as the primary data and train on them.

In one embodiment, the process 200 (and 310-330 as discussed), can be used to better combine in-distribution data with out-of-distribution data to improve the model accuracy. In one embodiment, an in-distribution report dataset and an out-of-distribution description dataset, can be utilized. The contrastive learning is used to increase cosine similarity for in-distribution and out-of-distribution data from the same classes and, at the same time, to decrease the similarity for sentences from different classes. The process then selects some sentences from the out-of-distribution data that are more similar to in-distribution data and append those to the training set. Second, a two-stage training is used to first train a model using the combined training data and then keep training on using only the in-distribution data. In this way, the process can avoid the performance loss due to the data distribution shift but can effectively improve the performance on the in-distribution data classification. In this way additional small quasi-labeled data can be used without needing additional large labeled data. Also, during a phase of training the classification model, data is only augmented data to the rare classes, simultaneously increasing data balance. Rare classes are defined as classes with fewer than K data items (e.g., sentences). Examples of other existing labeled data include labeled data for a similar task from slightly different domain. For instance, in a particular scenario it is desired to build a sentiment classification model for restaurant reviews. The process uses an existing labeled data for movie reviews to augment the training data for restaurant reviews.

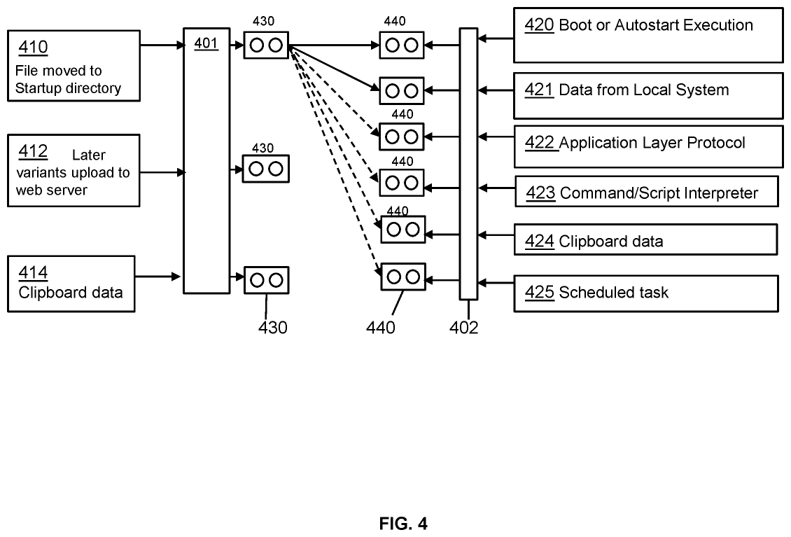

In one embodiment, the process may use quasi-labeled data including definition or description text for the target classes. For instance, for cyber attack techniques, MITRE ATT&CK provides descriptions for all attack techniques. Other examples of such quasi-labeled data include glossary or annotation guidelines. The process can also be used to prevent cyber attacks (in one embodiment it increases MicroF1 by 1 point and MacroF1 by 14 points on cybersecurity attack classification scale). FIGS. 4 and 5 show details of the process 200 as discussed in FIG. 2 and in the block diagram of FIG. 3.

FIG. 4 provides the encoding process (See 210) as shown by encoders 401 and 402. The block diagram of FIG. 4 illustrates the in-distribution and out-of-distribution encoding sentences using a foundation model (like BERT). For each example, one in-distribution sentence is paired with an out-of-distribution sentence in the same class. This is shown by the example of reference numeral 430 being paired with 440 (pairing in one instance sown by arrows). There are different boxes 410-414 and 420-425 provided to reflect each action.

Block 410 provides a Boot or Logon Auto-start execution. In this step, the LNK file is moved to the startup directory. Block 412 shows the Application Layer Protocol, where in one embodiment, later varieties are uploaded and the file to a web server via an HTTP post command. In 414 The GetClipborddata can be used to provide the Clipboard data.

Block/box 420 provides Boot or Logon Auto-start execution. In one embodiment, the operating system may have mechanisms for automatically running a program on system boot or account logon In 421, data from local system is provided (adversaries may also use Automated Collection on the local system). Application Layer Protocol is provided in 422 where data could also be concealed within the email messages themselves. Command and Script Interpreter is provided by 423. Applications such as AppleScripts do not need to call osascript to execute. Clipboard data can be provided in 424 (provides On iOS, which may can be accomplished by accessing the UIPasteboard.general.string field). Block/box 425 is only for only when the device is charging and indicates Scheduled tasks or jobs.

As discussed before, the contrastive learning can be used to maximize the cosine similarity between the embeddings of sentences of the two datasets from same class. It can also be used to learn better sentence representation. In one embodiment, the primary and auxiliary sentences can be encoded using a foundation model (such as BERT). For each example, one primary sentence can be paired with an auxiliary sentence in the same class, and an auxiliary sentence in a different class. Contrastive learning is then used to maximize the cosine similarity between the embeddings of sentences of the two datasets from same class.

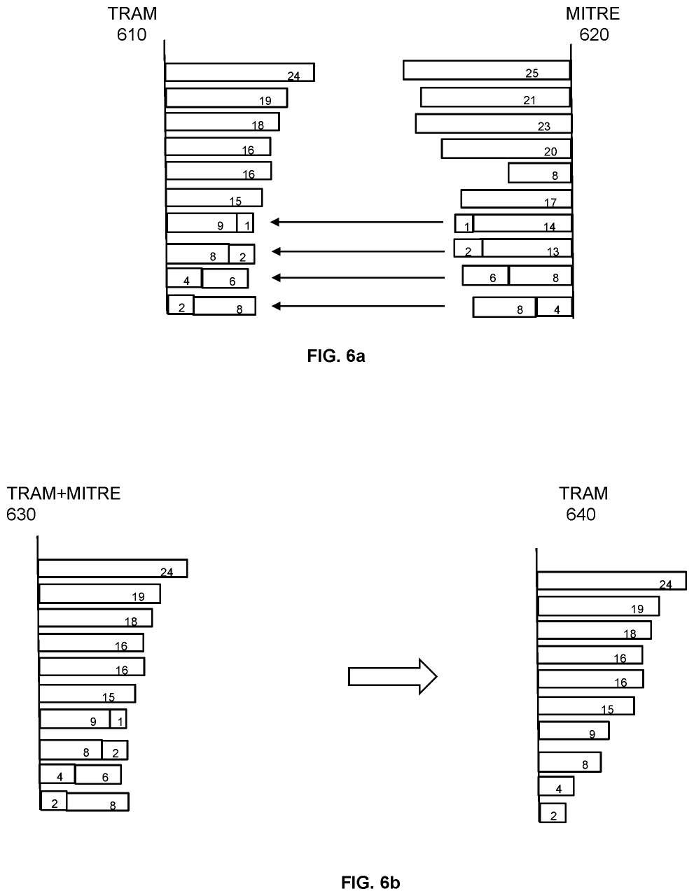

FIGS. 6a and 6b relate back to FIGS. 5a and 5b . . . . Reference numerals 610 and 620 show in-distribution dataset (e.g., TRAM) and out-of-distribution datasets (e.g. MITRE ATT&CK) respectively. TRAM enables researchers to “Test” and “Refine” Machine Learning (TRAM) models for identifying attack techniques in cyber threat intelligence reports. It allows training of ML models and validates the ML results. Similarly MITRE ATT&CK is a knowledge base of adversary tactics, techniques and case studies based on real-world observations, demonstrations and feedback from security teams and groups. MITRE ATT&CK can be incorporated here to provide out-of-distribution data. FIG. 6 shows an illustrative example of data augmentation for rare classes where K=10. The numbers in 610 and 620 show the number of sentences in each class in the TRAM and MITRE datasets. Note that the bottom four classes have fewer than 10 instances (9, 8, 4 and 2 respectively). Thus, we augment these four classes with similar samples from MITRE so that these classes have 10 sentences.

As discussed before. for a class to be augmented, compute the cosine similarities of sentences in the auxiliary data and in the primary data for the class. Then select top-k sentences from the auxiliary data with the highest similarity scores and append those sentences to the training data. This shows how the primary data with similar auxiliary data is augmented. As shown by the arrows, For a class to be augmented, compute the cosine similarities of sentences in the auxiliary data and in the primary data for the class. Then select top-k sentences from the auxiliary data with the highest similarity scores and append those sentences to the training data. Similarly as shown by 530 TRAM and MITRE data can be fine tune as shown at 540. A first finetuing using the foundation model (Step 1—with contrastive learning) is done with all primary data along with these selected sentences (Step 2 from auxiliary data) as shown at 570. Further finetuning of the foundation model from Step 3 is done on only the primary data as shown at 580.

Some example of this (using BERT) can be provided below:

| | BERT | | SecBERT | | SecureBERT | |
|---|---|---|---|---|---|---|
| Models | MiF₁ | MaF₁ | MiF₁ | MaF₁ | MiF₁ | MaF₁ |
| Primary only | | | | | | |
| (1) D^{P} (baseline 1) | 61.6 | 39.2 | 64.0 | 42.7 | 63.1 | 41.8 |
| (2) D^{P}→D^{P} | 60.1 | 38.1 | 63.4 | 41.8 | 63.4 | 41.6 |
| Augmentation w/all of | | | | | | |
| auxiliary | | | | | | |
| (3) D^{P} + D^{A} (baseline 2) | 56.0 | 42.9 | 59.3 | 48.0 | 56.0 | 43.1 |
| (4) D^{P} + D^{A}→D^{P} | 61.0 | 44.9 | 63.6 | 50.4 | 62.9 | 47.4 |
| Augmentation w/similar | | | | | | |
| auxiliary | | | | | | |
| (5) D^{P} + D^{A}^{_{—}}^{sim} | 59.4 | 42.4 | 63.5 | 48.3 | 64.0 | 48.7 |
| (6) D^{P} + D^{A}^{_{—}}^{sim}→D^{P} | 62.9 | 44.8 | 63.8 | 48.2 | 65.4 | 50.2 |

In another example:

| | BERT | | SecBERT | | SecureBERT | |
|---|---|---|---|---|---|---|
| Models | MiF₁ | MaF₁ | MiF₁ | MaF₁ | MiF₁ | MaF₁ |
| Augment Minority Classes | | | | | | |
| Self Data Augmentation | | | | | | |
| (a) D^{P} + D^{P}^{_{—}}^{same}→D^{P} | 61.6 | 39.2 | 63.5 | 42.7 | 63.1 | 41.8 |
| (b) D^{P} + D^{P}^{_{—}}^{swap}→D^{P} | 61.6 | 39.2 | 63.0 | 42.7 | 63.1 | 41.8 |
| Using Auxiliary Data | | | | | | |
| (c) D^{P} + D^{A}^{_{—}}^{rand}→D^{P} | 61.6 | 43.4 | 63.4 | 49.1 | 66.2 | 49.4 |
| (d) D^{P} + D^{A}^{_{—}}^{sim}→D^{P} | 62.9 | 44.8 | 63.8 | 48.2 | 65.4 | 50.2 |
| Augment All Classes | | | | | | |
| (e) D^{P} + D^{A}^{_{—}}^{randall}→D^{P} | 60.9 | 43.6 | 62.8 | 49.4 | 65.3 | 50.5 |
| (f) D^{P} + D^{A}^{_{—}}^{simall}→D^{P} | 61.5 | 43.8 | 62.4 | 48.1 | 64.6 | 47.5 |

Both of these can be used in preventing cyber attacks.

As discussed, when looking at cyberattack reports and the likes, some sentences are selected from the out of-distribution dataset that are most similar to at least one in-distribution sentence of the same class. Specifically, for each sentence in the out-of-distribution dataset, its cosine similarity is computed with each sentence in the same class but in the in-distribution dataset. Then the highest similarity score is selected as the score for this sentence in the out-of-distribution dataset. Subsequently, the most similar k sentences are selected from out-of-distribution dataset for classes with fewer than k sentences in the in-distribution dataset. Those sentences are appended to the training data.

In FIG. 6, the fine tuning of the foundation models is shown. (The fine tuning may be performed with contrastive learning as shown in FIGS. 2 and 4.) This is done for sequence classification with all in-distribution data along with the selected sentences from out-of-distribution data (610). In one embodiment, further finetuning of the foundation model is performed but only on the in-distribution data (620).

In this way, in one embodiment a method, computer system, and a computer program product are provided for data augmentation for training an artificial intelligence (AI) engine. The technique comprises encoding an in-distribution dataset having a plurality of components and an out-of-distribution dataset also having a plurality of components. The encoding is performed using a foundation model. The techniques also comprises pairing one in-distribution component from the dataset with an out-of-distribution component from the dataset in a same class to provide a first set of paired component and pairing another in-distribution component with another out-of-distribution component in a different class using the contrastive learning model to provide a second set of paired components. The first and second set of pared components are then augmented to generate an augmented training dataset. The foundation models is adjusted by using he augmented training dataset to train the AI engine. In one embodiment, the adjusting comprises tuning and fine tuning the foundation models, reiteratively as appropriate. The in-distribution dataset is a labeled training dataset designated for a target task and the out-of-distribution dataset is a quasi-labeled dataset designated for a similar target task. In one embodiment, the in-distribution component and the out-of-distribution component are an in-distribution sentence and an out-of-distribution sentence respectively. The adjusting and tuning/fine-tuning is used to train the AI engine. In one embodiment, as discussed, this can be performed in a two stage process. In one embodiment, cosine similarity of each sentence or component is used and a scoring is established for comparison. In one embodiment, the another in-distribution component or the another out-of-distribution used to provide the second set of paired component may be the same as the in distribution component or the out-of-distribution component used to provide the first set of paired components.

The descriptions of the various embodiments of the present invention have been presented for purposes of illustration but may be not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for data augmentation for training an artificial intelligence (AI) engine, comprising:
encoding an in-distribution dataset having a plurality of in-distribution components, and an out-of-distribution dataset having a plurality of in-distribution components, wherein said encoding is done using a foundation model;
pairing an in-distribution component with an out-of-distribution component in a same class and using a contrastive model to provide a first set of paired components;
pairing another in-distribution component with another out-of-distribution component in a different class using said contrastive learning model to provide a second set of paired components;
augmenting said first and second set of paired components to generate an augmented training dataset; and
adjusting said foundation model by using said augmented training dataset to train said AI engine.

2. The method of claim 1, wherein said adjusting comprises tuning and reiteratively fine-tuning said foundation model.

3. The method of claim 1, wherein said in-distribution dataset is a labeled training dataset designated for a target task.

4. The method of claim 3, wherein said out-of-distribution dataset is a quasi-labeled dataset designated for a similar target task.

5. The method of claim 1, wherein said in-distribution component and said out-of-distribution component are an in-distribution sentence and an out-of-distribution sentence respectively.

6. The method of claim 5, wherein said adjusting is used for training said foundation model.

7. The method of claim 6, wherein training said AI engine is performed through a two-stage training process.

8. The method of claim 7, wherein said two stage training process comprises a first training stage that is performed using an augmented dataset and a second training stage that is performed using said in-distribution dataset.

9. The method of claim 8, wherein said contrastive learning model is used to maximize a cosine similarity between a plurality of embeddings of sentences of the two datasets from said same class.

10. The method of claim 9, further comprising:
for each sentence in said out-of-distribution dataset, computing a cosine similarity with each sentence in said same class in said in-distribution dataset; and providing a score based on a level of similarity.

11. The method of claim 10, further comprising comparing said scores indicating similarities based on similarity of each sentence in said out-of-distribution dataset.

12. The method of claim 11, further comprising selecting a score with a highest similarity score amongst said out-of-distribution dataset.

13. The method of claim 12, further comprising: selecting a sentence from said out-of-distribution dataset for classes with fewer than k sentences in said in-distribution dataset.

14. The method of claim 13, further comprising appending selected sentences to a training dataset.

15. A computer system for data augmentation for training an artificial intelligence (AI) engine, comprising:
one or more processors, one or more computer-readable memories and one or more computer-readable storage media;
program instructions, stored on at least one of the one or more storage media for execution by at least one of the one or more processors via at least one of the one or more memories, to encode an in-distribution dataset and an out-of-distribution dataset using a foundation model; wherein said encoding is done using a foundation model;
program instructions, stored on at least one of the one or more storage media for execution by at least one of the one or more processors via at least one of the one or more memories, to pair an in-distribution component with an out-of-distribution component in a same class using a contrastive model to provide a first set of paired components;
program instructions, stored on at least one of the one or more storage media for execution by at least one of the one or more processors via at least one of the one or more memories, to pair another in-distribution component with another out-of-distribution component in a different class using said contrastive learning model to provide a second set of paired components;
program instructions, stored on at least one of the one or more storage media for execution by at least one of the one or more processors via at least one of the one or more memories, to augment said first and second set of paired components to generate an augmented training dataset; and
program instructions, stored on at least one of the one or more storage media for execution by at least one of the one or more processors via at least one of the one or more memories, to adjust said foundation model by using said augmented training dataset to train said AI engine.

16. The computer system of claim 15, wherein said adjusting comprises tuning and reiteratively fine-tuning said foundation model.

17. The computer system of claim 16, wherein said in-distribution dataset is a labeled training dataset designated for a target task.

18. The computer system of claim 17, wherein said another in-distribution component or said another out-of-distribution used to provide said second set of paired component may be the same as said in distribution component or said out-of-distribution component used to provide said first set of paired components.

19. A computer program product for data augmentation used for training an artificial intelligence (AI) engine, comprising:
one or more computer readable storage media;
program instructions, stored on at least one of the one or more storage media for execution by at least one of the one or more processors via at least one of the one or more memories, to encode an in-distribution dataset and an out-of-distribution dataset using a foundation model; wherein said encoding is done using a foundation model;
program instructions, stored on at least one of the one or more storage media for execution by at least one of the one or more processors via at least one of the one or more memories, to pair an in-distribution component with an out-of-distribution component in a same class using a contrastive model to provide a first set of paired components;
program instructions, stored on at least one of the one or more storage media for execution by at least one of the one or more processors via at least one of the one or more memories, to pair another in-distribution component with another out-of-distribution component in a different class using said contrastive learning model to provide a second set of paired components;
program instructions, stored on at least one of the one or more storage media for execution by at least one of the one or more processors via at least one of the one or more memories, to augment said first and second set of paired components to generate an augmented training dataset; and
program instructions, stored on at least one of the one or more storage media for execution by at least one of the one or more processors via at least one of the one or more memories, to adjust said foundation model by using said augmented training dataset to train said AI engine.

20. The computer program product of claim 19, wherein said adjusting comprises tuning and fine turning said foundation models.
